(19) United States
(12) Patent Application Publication
(10) Pub. No.: US 2003/0006391 A1
(43) Pub. Date: Jan. 9, 2003

(54) Device and method for controlling the pressure of a hydraulic circuit

(76) Inventors: Karlheinz Mayr, Bregenz (DE); Markus Eisele, Friedrichshafen (DE); Walter Kill, Friedrichshafen (DE); Hubert Remmlinger, Friedrichshafen (DE); Robert Ingenbleek, Kressbronn (DE); Harry Nolzen, Tettnang (DE); Torsten Buchner, Friedrichshafen (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/147,772

(22) Filed: May 16, 2002

(30) Foreign Application Priority Data
May 18, 2001 (DE) 101 24 338.3

(51) Int. Cl. F16K 31/02

(52) U.S. Cl. 251/129.18

(57) ABSTRACT

The oil supply with an orientation toward requirements in a transmission is implemented by a system of control and regulating modules. Mentioned in particular, here is a combined control and regulating module that is electronically driven and mechanically regulates the pressure. The controlled variable is a coil current that increases proportionally as the pressure increases. One disadvantage is that, in the case of a system failure, no coil current flows and the pressure is also minimal. In the present invention, by contrast, a maximum pressure is provided in the hydraulics even without current. This ensures that during a system failure that the operation of control elements that can only be shifted using high pressure will continue. This is implemented via a combined control and regulating module. The control unit is a magnet system that moves the regulating module and a sliding valve (14). Moreover, a spring system is provided that holds the sliding valve (14) at the starting position when no current is present.

The present invention relates to a device for regulation of the pressure in an hydraulic circuit having a drive unit of a proportional magnet for actuation of a control element in a proportional pressure regulation valve, especially for the clutch actuation in a motor vehicle automatic transmission as per patent claim 1. Furthermore, the invention includes a method for controlling the device according to the preamble to claim 9.

In a transmission, especially a motor vehicle automatic transmission, the pressure in an hydraulic circuit is regulated with an orientation to requirements. While the pressure level for the lubricating oil supply of the transmission components can be kept low, the pressure must be sharply increased during the gear shifting operations in order to rapidly fill shifting components, for example.

According to the state-of-the-art, pressure regulators that drive secondary actuators for clutch actuation are used to regulate the pressure in hydraulic circuits. Described in the German patent application 100 03 896.4 by the applicant, a pressure regulator that adjusts a secondarily connected sliding valve according to requirements via a stationary proportional magnet, a magnet coil, a movable magneto inductor and a specific drive system, and thereby regulates the pressure in the hydraulic circuit.

According to the aforesaid document, the magneto inductor is in its starting position when no load is applied to the magnetic coil and the hydraulic pressure in the system is low. As the current intensity increases, a magnetic flux is produced within the magnet coil and creates a magnetic circuit across the components and air gaps. Because of this magnetic flux, the magnetic core attracts the magneto inductor. The relationship of coil current intensity to the travel, around the magneto inductor is adjusted on the basis of the magnetic forces, and is proportional across a wide Region. However, if the distance from the magneto inductor to the magnetic core is reduced down to a certain point, the magnetic forces increase over-proportionally, and the magneto inductor snaps abruptly to the magnetic core. In this magnetic core holdover position of the magneto inductor, the magnetic forces are great enough that the current can be reduced to a specific value without the magneto inductor releasing again. If the magneto inductor is located in the holding position, the pressure in the hydraulic circuit is at its maximum.

This pressure regulation system is suitable for a motor vehicle operation in which, in the event of a power failure, the system does not have to rely on high pressure in the hydraulic circuit in order, for example, to actuate the clutches.

However, increased requirements for the safety of the in passenger car user are mandatory, in the event of a power failure, which a pressure regulation system does not offer, as noted in the cited publication. The so-called “fail-safe behavior” (behavior in the event of a power failure) of the specified pressure regulation system is not capable of producing pressure, without a current as would be necessary to actuate the clutches so that the vehicle can be placed back into operation.

This requirement of providing a high pressure when no current is available, is the subject of the present invention.

This objective is achieved by using a pressure regulation system and a method for controlling the system which, employing the characteristics of patent claims 1 and 9, holds a sliding valve against a high pressure in the hydraulic circuit, even if there is no current available to the pressure regulation system.

The pressure regulation system of the present invention is comprised of a sliding valve that directly sets up the pressure in the hydraulic circuit and a control unit that controls the movement of the sliding valve.

The control unit is located within a magnet housing. It is comprised essentially of a magnetic coil and an magnetic core and a magneto inductor. A variable current flows in the magnetic coil, which generates a magnetic flux in the coil core that is configured at varying intensities, depending on the level of the flowing coil current. Located in the coil core are a magnetic core and a movable magneto inductor that is coupled to the sliding valve. The magnetic core sits on a magnetic core or a rotor slide between the magnetic housing and the magneto inductor. It is held up against the magnet housing via a magnetic core spring and, on the other side, a magnetically inert disk with an anti-attractive effect separates it from the magneto inductor. The magnetic flux generated by the coil current flows through the magnet housing, the magneto inductor and the magnetic core, and in the process produces a magnetic force in the air gaps between these components. If no coil current is flowing, no magnetic forces are produced and the components are located in their starting position. The starting position of the magneto inductor is consequently set only by the forces of the pre-tensioning spring, the adjustment spring and magnetic core spring applied to it. The total spring force is set in such a manner that it holds the magneto inductor in its starting position against the force of pressure in the hydraulic circuit, which acts on the sliding valve. In this way it is ensured that the magneto inductor remains in its starting position when no coil current is flowing and, as a result, the sliding valve opens and thus maximum pressure is created in the hydraulic circuit.

If there is now a current pulse on the coil, a magnetic flux also surges. This magnetic flux creates a magnetic force in the air gaps great enough that the magneto inductor moves the magnetic core across the inductor rod/magnetic core bearing up to the magnet housing, and there the two components suddenly become a Region. The magnetic core continues to rest against the magnet housing, even when the coil current subsequently drops. The reason for this lies in the magnetic force, which, due to the now minimal air gap between magnetic core and magnet housing, is sufficiently strong even when magnetic flux is low. However, the magneto inductor separates from the magnetic core and remains at a distance from the magnetic core that corresponds to the magnetic force and the position of the control valve.

If the coil current is then increased again, the magnetic flux increases and with it also the magnetic force in the air gap between magnetic core and magneto inductor. The magnetic core is formed is such a manner that the increase of the coil current exerts a force proportional to this on the magneto inductor, the proportionality of coil current to the movement of the magneto inductor being limited by a minimum distance from magneto inductor to the magnetic core. Below this minimum distance, specifically, the magnetic force increases over-proportionally in relation to the coil current, which results in a sudden “snap” of the magneto inductor against the magnetic core. However, due to the magnetically inert disks between magnetic core and magneto inductor, the distance from magneto inductor to magnetic core is prevented from becoming so small that the magnetic force increases over-proportionally.

The sliding valve closes in accordance with the movement of the magneto inductor. A continual increase of the coil current consequently means a continuous drop of pressure in the hydraulic circuit.

When the coil current is reduced, the magnetic force drops and the distance between magnetic core and magneto inductor gets larger. Due to the coupling of magnetic core and sliding valve, the sliding valve then opens. In this case the pressure rises again in the hydraulic circuit.

If the coil current is reduced to a determinable value, the magnetic core releases again from the magnet housing because of the magnet spring. This determinable value depends on the size of the contact surface of the magnetic core and the magnitude of the spring constant.

Especially advantageous in this invention is a good “fail safe” behavior of the pressure regulation system which, in particular, means that in the event of a failure of the voltage supply to the control unit, the sliding valve is opened and in this way a maximum pressure is applied in the hydraulic circuit. This maximum pressure is necessary in order to actuate control elements, for example clutches, and should, therefore, be available at anytime.

Furthermore, the combination of control module and sliding valve makes it possible on the one hand to eliminate at least one valve, for example a holding valve or pressure reduction valve, and on the other hand to eliminate a pilot phase.

### BRIEF DESCRIPTION OF THE DRAWINGS

Other characteristics that are essential for the invention and the resulting advantages can be derived form the following descriptions of the design example of the invention: Shown are

FIG. 1 the device for controlling a proportional magnet with the sliding valve and

FIG. 2 a diagram showing the pressure and coil current curves over time.

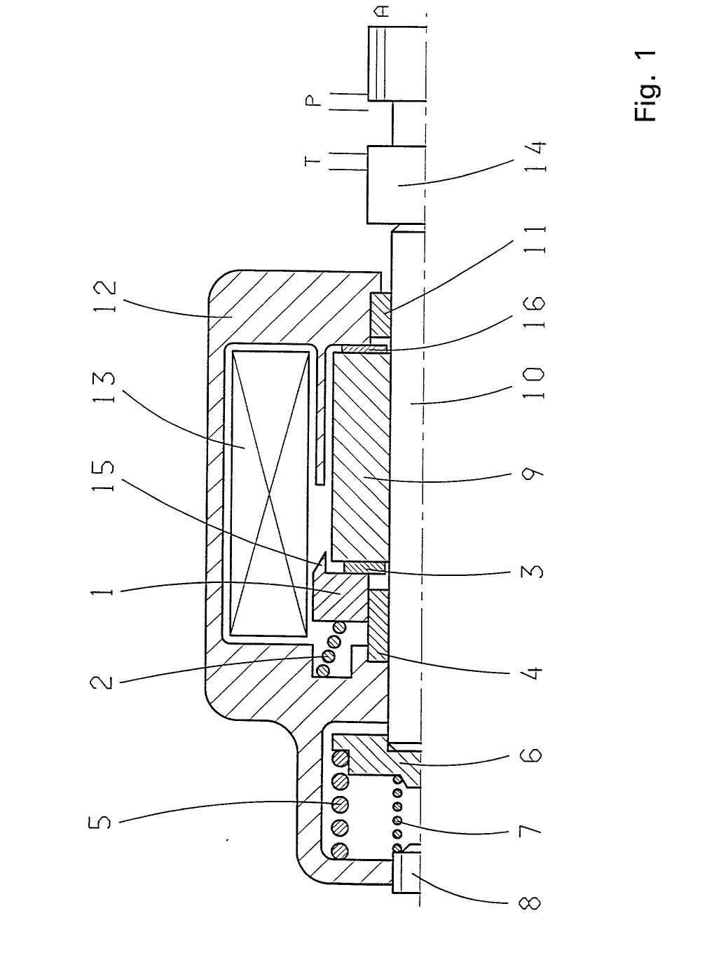

Shown in FIG. 1 is the structure of a device with which the pressure in the hydraulic circuit is regulated via a sliding valve 14 and a control unit for sliding valve 14.

A magnet housing 12 can be seen, which essentially encloses and protects the functional components, but also conducts the magnetic flux in a controlled manner. Located in the front part of magnet housing 12 is a serial spring pair consisting of a pre-tensioning spring 5 and an adjustment spring 7. Pre-tensioning spring 5 is located between magnet housing 12 and a spring plate 6, and adjustment spring 7 also abuts against spring plate 6 and is adjusted on the other side using a set screw 8. Another serial spring, magnetic core spring 2, is mounted between magnet housing 12 and a movable magnetic core 1. If no voltage is applied to magnet coil 13, magnetic core spring 2 and pre-tensioning spring 5 are pre-tensioned so that their total spring force opens sliding valve 14 to the maximum extent. This total spring force is dimensioned larger than the maximum force of pressure that is exerted by the hydraulic circuit on the end face of sliding valve 14. In this way it is ensured that sliding valve 14 remains in its limit position and is not pushed by the opposing force of pressure of the hydraulics into a Region of control.

Located in the main part of magnet housing 12 is a magnet coil 13. A magnet rod 10 along with an magneto inductor 1 runs through its coil core. Furthermore, there is in the coil core a magnetic core 1 that can move back and forth on a combined magneto inductor rod/magnetic core bearing. Another bearing, magneto inductor rod bearing 11 is located on the other side of magnet housing 12. A wedge-shaped plunge step 15 on magnetic core 1 implements the proportional magnet part, which means that between this plunge step 15 and magneto inductor 9 the magnetic force is formed in such a manner that magneto inductor 9 is moved proportionally to the magnetic force. A magnetically inert disk 3 with an anti-attraction effect between magnetic core 1 and magneto inductor 9 prevents the components from coming too close, and over-proportionally magnetic forces from developing or a residual magnetism from resulting in the components that influence the characteristics of the components.

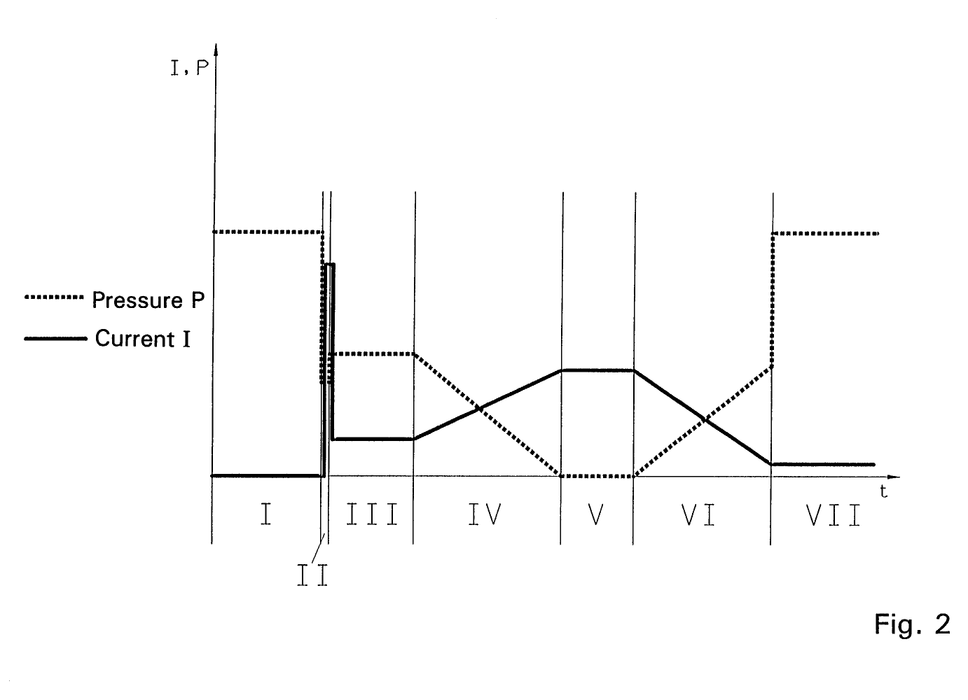

In FIG. 2 a diagram is shown in which pressure P (intermittent line) and coil current I (continuous line) are plotted over time. The diagram is divided into six characteristic Regions for the method of the invention.

In Region I, no current is applied to magnetic coil 1. In this way magneto inductor 9 remains in its starting position and sliding valve 14 is open. In this open sliding valve position, the pressure in the hydraulic circuit is at a maximum.

If then a current pulse is briefly present on the magnet coil 13, as represented in Region II, a strong magnetic flux results in the coil core and produces high magnetic forces in the air gaps between the interfaces of the components through which it flows. Based on these high magnetic forces, magnetic core 1 and magneto inductor 9 move “in the manner of a switching magnet” in the direction of the spring-side magnet housing 12 until making contact and in this position eliminate the spring force of magnetic core spring 2. The total spring force that acts on magneto inductor 9 or sliding valve 14 is consequently reduced. Then the force of pressure of the hydraulics is larger than the total spring force, and as a result sliding valve 14 is partially closed and the pressure drops sharply during the time period of the coil current pulse.

At the adjacent interfaces of magnetic core 1 and magnet housing 12, because of the minimized air gap, a magnetic force results that is strong enough that the coil current can be reduced without magnetic core 1 release from magnet housing 12. Magneto inductor 9, on the other hand, releases from magnetic core 1, since in this case the air gap, due to magnetically inert disk 3, is greater and the magnetic force as a result turns out to be less. Corresponding to the movement of magneto inductor 9, sliding valve 14 opens partially, and the pressure in the hydraulic circuit increases accordingly. The pressure drop is stopped and the pressure is stabilized. This effect is shown in Region III.

If the coil current continuously increases, as is evident in Region IV, magneto inductor 9 is proportionally drawn to plunge step 3 [sic] of magnetic core 1. In the same magnitude, sliding valve 14 closes and the pressure drops in a manner likewise proportionally to the coil current. At maximum coil current, pressure value zero is reached. (Region V).

If one reduces the coil current again as per Region VI, the pressure increases proportionally.

When a determinable coil current value falls short, as in Region VII, magnetic core 1 separates from magnet housing 12 and the sliding valve opens. The pressure in the hydraulic circuit then increases abruptly to the maximum pressure level.

### REFERENCE NUMBERS

1 movable magnetic core

2 magnetic core spring

3 magnetic core counter-attraction disk

4 combined magneto inductor rod bearing/magnetic core bearing

5 pre-tensioning spring

6 spring plate

7 adjustment spring

8 set screw

9 magneto inductor

10 magneto inductor rod

11 front magneto inductor rod bearing

12 magnetic housing

13 magnetic coil

14 sliding valve

15 plunge phase

16 magnetically inert disk

| | |
|---|---|
| I | Region |
| II | Region |
| III | Region |
| IV | Region |
| V | Region |
| VI | Region |

1. A device for the control of a proportional magnet having a magnetic core (1), an magneto inductor (9) and a magnetic core (13) in a magnet housing (12), wherein the proportional magnet is connected to an electronic control apparatus for the actuation of a control element in a relay valve or a proportional pressure regulation valve, in particular a pressure control valve for the clutch actuation in an automatic motor vehicle transmission, and the magneto inductor (9) is movable back and forth between a control area and a retention range having a magnetic holding position of the magneto inductor, wherein the movements of the magneto inductor (9) are detected in the device and a defined transition of the magneto inductor (9) from the holding position into the retention range is executable and means are provided which hold the magneto inductor (9) in a starting position as long as no current flows to the magnet coil (13).

2. The device as cited in claim 1, wherein the means, for example, are configured as springs, which hold the magneto inductor (9) in its starting position when there is high pressure in the hydraulic circuit and an increase of the coil current moves the magneto inductor (9) and the magnetic core (1) out of their starting position and thus produces a lowering of the pressure in the hydraulic circuit.

3. The device as cited in any of the foregoing claims, wherein a magnetic core spring (2) and a pre-tensioning spring (5), which hold the magneto inductor (9), are pre-tensioned, their spring forces being found in equilibrium with the pressure in the hydraulic circuit and a support force on the magnet housing (12).

4. The device as cited in claim 3, wherein the magnetic core spring (2) is located between magnetic core (1) and magnet housing (12) and the pre-tensioning spring (5) is located between the magnet housing (12) and a spring plate (6), which is connected to the magneto inductor (9).

5. The device as cited in any of the foregoing claims, wherein an adjustment spring (7) is provided between a set screw (8) sitting on the magnet housing (12) and the spring plate (6).

6. The device as cited in any of the foregoing claims, wherein at least one magnetically inert operating material is provided which separates the magneto inductor (9) from magnetically active components.

7. The device as cited in claim 6, wherein the magnetically inert operating material are configured as magnetically inert disks (16), which have an anti-adhesion effect and which are located at the end faces of the magneto inductor (9) on the magnetic core (1) and on the magnet housing (12).

8. A method for controlling a proportional magnet according to one or more of claims 1 through 7, wherein the magneto inductor (9), in connection with the control element, holds the pressure in the hydraulic circuit at a maximum if no current is flowing in the magnet coil (13) and the magneto inductor (9) at this time is located in its starting position.

9. The method as cited in claim 8, wherein a pulse of the coil current produces a magnetic force that attracts the magnetic core (1) and the magneto inductor (9) to the magnet housing (12) and holds them there.

10. The method as cited in claim 9, wherein, when there is a subsequent coil current reduction, the magnetic force between magnetic core (1) and magnet housing (12) is sufficiently high and furthermore holds the magnetic core (1) in its position.

11. The method as cited in claim 9, wherein, when there is a subsequent coil current reduction, the magneto inductor (9) is moved out of its holding position into it's a area of control.

12. The method as cited in any of the claims 8 through 11, wherein, in the area of control, the movements of the magneto inductor (9) and the sliding valve (14) are proportional to the coil current intensity.

13. The method as cited in any of claims 8 through 12, wherein, when there is an adjustable coil current intensity, the magnetic core (1) is released form the magnet housing (12).

14. The method as cited in claim 13, wherein, when the magnetic core (1) releases from the magnet housing (12), the spring forces act and hold the magneto inductor (9) in its starting position and open the sliding valve (14).
